(19) United States
(12) Patent Application Publication
(10) Pub. No.: US 2006/0015528 A1
(43) Pub. Date: Jan. 19, 2006

(54) Generic representation of optional values

(75) Inventors: Anders Hejlsberg, Seattle, WA (US); Anthony J. Moore, Seattle, WA (US); Brian M. Grunkemeyer, Redmond, WA (US); Donald F. Box, Bellevue, WA (US); Gang Peng, Bellevue, WA (US); Krzysztof J. Cwalina, Sammamish, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/891,459

(22) Filed: Jul. 14, 2004

(51) Int. Cl. G06F 17/00

(52) U.S. Cl. 707/104.1

(57) ABSTRACT

A generic nullable type that is capable of representing null values for reference, value, and other types in a uniform manner is described. The nullable generic type includes at least two portions: a container portion and a Boolean member portion. The container portion can hold other objects of other types, including both reference and value types. The Boolean member portion indicates whether the type held by the container has a value or not. Specifically, when the Boolean member is true, the values of the general type held by the container are valid. When the Boolean member is false, the values of the general type are invalid or undefined to represent an unspecified or null condition. Stack memory usage for the nullable type, a comparison of two objects of the nullable type, and an example database manipulation using the nullable type are also described.

### TECHNICAL FIELD

This disclosure relates in general to representing optional values in a generic fashion and in particular, by way of example but not limitation, to a generic mechanism for representing null conditions of different types.

### BACKGROUND

Software is the coding that directs the operation of computing devices. Originally, programmers wrote each piece of software from scratch to be tailored to a particular task and/or processing device. Eventually, reusable libraries were gradually developed that enabled pieces of coding to be used repeatedly in similar or related situations, even by different programmers.

As programming approaches and foundations evolved, application programming interfaces (APIs) and programming schemas were developed to standardize and unify programming methodologies that were previously wildly variant and relatively incompatible. Modem programming therefore often involves employing APIs and schemas in conjunction with reusable libraries. Unfortunately, this evolution has inadvertently created many inefficient vestigial programming artifacts that are actually spread and perpetuated by these standardizations programming constructs. For example, one resulting software programming artifact is a duality between reference types and value types.

Reference types are variables that are stored on a heap and referenced by a pointer stored on the stack. Value types are variables that are stored directly on the stack. Consequently, variables that are represented as reference types can be uninitialized (termed “null”), but variables that are represented as value types cannot be established in an uninitialized condition without risking indeterminate or even catastrophic results. This nullification issue can present a problem in a myriad of situations, including data base accessing.

The nullification problem has been previously addressed with many different strategies. Examples of such strategies include tuples, boxing, variants, convoluted pointer manipulations, and so forth. However, each of these strategies have one or more drawbacks including memory inefficiencies, runtime inefficiencies, loss of strong typing, proliferation of non-standard types, and so forth. By way of example, boxing turns value types into reference types, with the accompanying greater memory usage and increased processing demands to handle the inherent pointer overhead.

Accordingly, there is a need for schemes and/or techniques that can efficiently and/or uniformly address the above-described inadequacies of existing strategies for addressing the nullification issue.

### SUMMARY

A generic nullable type that is capable of representing null values for reference, value, and other types in a uniform manner is described. The nullable generic type includes at least two portions: a container portion and a Boolean member portion. The container portion can hold other objects of other types, including both reference and value types. The Boolean member portion indicates whether the type held by the container has a value or not. Specifically, when the Boolean member is true, the values of the general type held by the container are valid. When the Boolean member is false, the values of the general type are invalid or undefined to represent an unspecified or null condition. Stack memory usage for the nullable type, a comparison of two objects of the nullable type, and an example database manipulation using the nullable type are also described.

Other method, system, approach, apparatus, device, media, procedure, arrangement, etc. implementations are described herein.

### BRIEF DESCRIPTION OF THE DRAWINGS

The same numbers are used throughout the drawings to reference like and/or corresponding aspects, features, and components.

FIG. 1 is an example of memory usage for reference types.

FIG. 2 is an example of memory usage for value types.

FIG. 3 is an example format for a nullable<T> generic type.

FIG. 4 is an example of memory usage for nullable<T> generic types.

FIG. 5 is a flow diagram that illustrates an example of a method for comparing two nullable type objects.

FIG. 6 is a flow diagram that illustrates an example of a method for utilizing a nullable type object when manipulating a database.

FIG. 7 illustrates an example of a computing (or general device) operating environment that is capable of (wholly or partially) implementing at least one aspect of generically representing optional values as described herein.

### DETAILED DESCRIPTION

### Introduction

In a described implementation, a nullable generic type (which is termed “Nullable<T> generic type” in C# generic syntax) may be created, used, exchanged, and so forth. The nullable<T> generic type can be used to represent values of types generally. Although the underlying type is specified at creation of the nullable<T> type, the value thereof may or may not be specified. For example, the nullable<T> generic type includes a container that can hold any given general type (e.g., reference types, values types, etc.), which may take a value or may be null. The nullable<T> generic type also includes a Boolean member capable of having a true or false value.

When the Boolean member is false, the general type held by the associated container is considered to be invalid and is thus null. When the Boolean member is true, the general type and any value(s) thereof that are held by the associated container are considered to be valid. In this manner, as is described further herein below, any general type can have an unspecified (e.g., an uninitialized) or null representation using a uniform mechanism.

### Examples of Memory Usages for Reference and Value Types

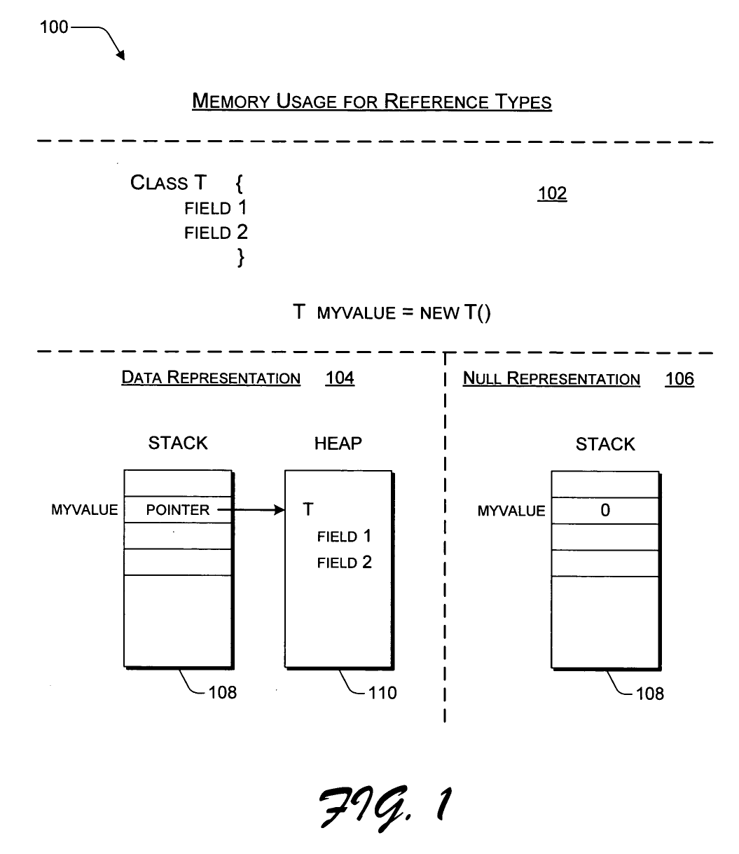

FIG. 1 is an example of memory usage 100 for reference types. A data representation 104 and a null representation 106 are illustrated. A reference type class T is shown and instantiated at 102. The reference type class T is defined as follows:

| | |
|---|---|
| Class T | { |

field 1
field 2

}.

A “myvalue” instantiation of the reference type class T is created with:
T myvalue=new T( ).

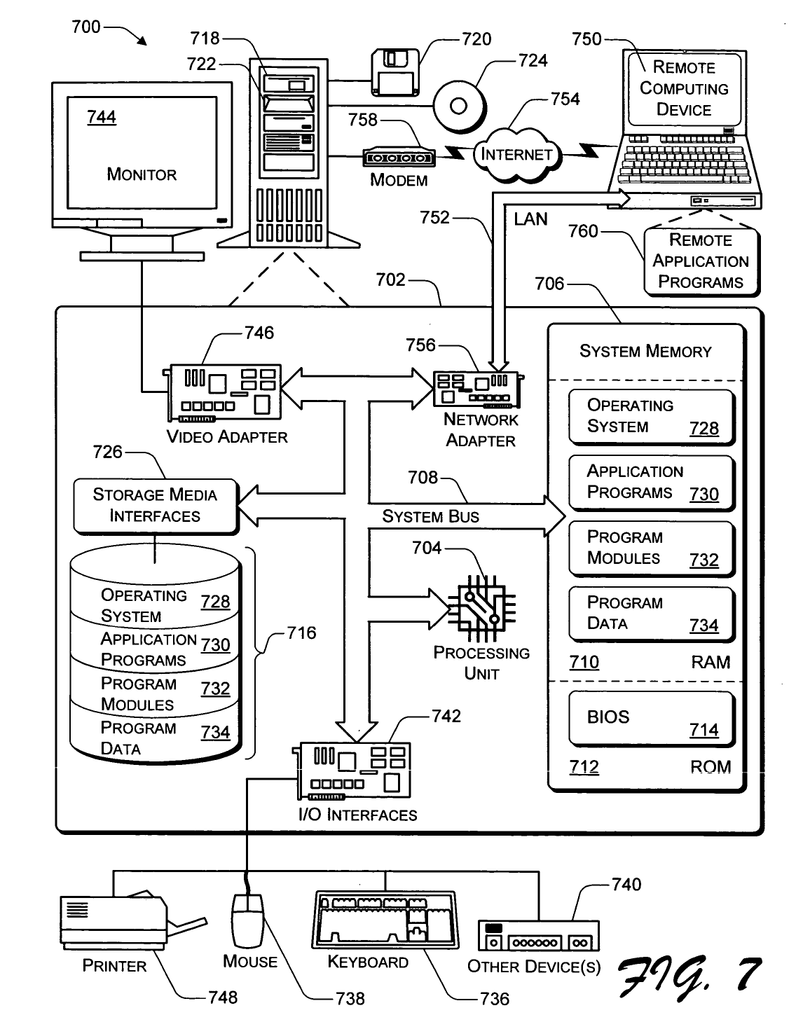

Data representation 104 for a reference type includes a stack 108 and a heap 110. Stack 108 and heap 110 can be part of one or more memories of a processing device (not shown in FIG. 1). An example of such a processing device and memory thereof is described further below with reference to FIG. 7.

With data representation 104 for a reference type, a portion of heap 110 is allocated to store the values of the reference type. “myvalue” is assigned a location on stack 108 that stores a pointer to the corresponding portion of heap 110 which stores the values of “field 1” and “field 2”. Thus, two memory areas as well as additional overall memory space are used for reference types. Moreover, tracking pointer references and maintaining heap 110 (e.g., memory allocations and deallocations) requires processing bandwidth.

With null representation 106 for a reference type, there is also a location on stack 108 to which “myvalue” is assigned. However, this location, instead of holding a pointer, typically holds the value of zero (0) (or some other value that represents “null” or the absence of a pointer). In this manner, the instantiation “myvalue” for the reference class T may have an unspecified (e.g., an uninitialized) value.

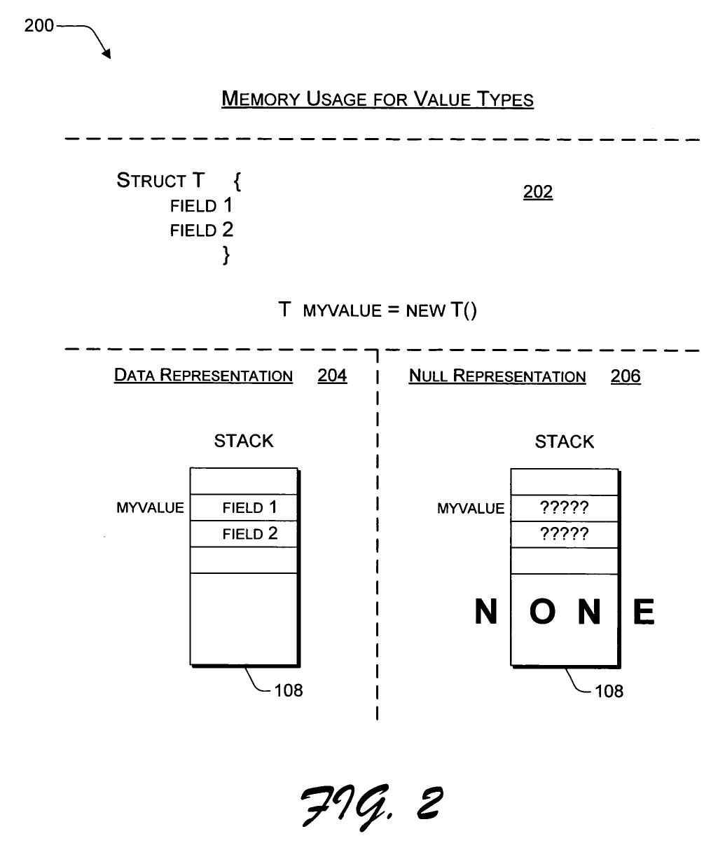

FIG. 2 is an example of memory usage 200 for value types. A data representation 204 and a would-be null representation 206 are illustrated. A value type class T is shown and instantiated at 202. The value type class T is defined as follows:

| | |
|---|---|
| Struct T | { |

field 1
field 2

}.

A “myvalue” instantiation of the value type class T is created with:
T myvalue=new T( ).

Examples of value types include integer, long, and so forth. Value types are stored on stack 108 without reference to a heap. Accordingly, both data representation 204 and null representation 206 include a stack 108.

With data representation 204 for a value type, “myvalue” is assigned a location on stack 108 that stores the actual values of “field 1” and “field 2” for the “myvalue” instantiation of the value type class T. A heap need not be used. Consequently, the additional memory space and processing demands that are attributable to heap usage with reference types are avoided.

With an attempted null representation 206 for a value type, there is still no heap usage. Hence, there is no mechanism for indicating “null”, as evidenced by the word “NONE” printed on stack 108. More specifically, as evidenced by the “?????” printed at the memory location of stack 108 to which “myvalue” is assigned, there is no foolproof manner to indicate null because there is no value that can necessarily be safely interpreted only as null for variables of “field 1”. For example, a stored value (as a result of initialization or otherwise) of zero in place of the “?????” can be misinterpreted, especially by a non-human program, to be a legitimate value instead of an intended null indicator. In other words, any selected null-indicating default value may be misinterpreted to be a genuine value in the defined range of the given value type, especially when considering interoperability with a myriad of computing environments worldwide. Thus, there is no guaranteed or even highly probable manner to successfully implement a null representation 206 for value types.

### Example Descriptions of Nullable<T> Generic Type

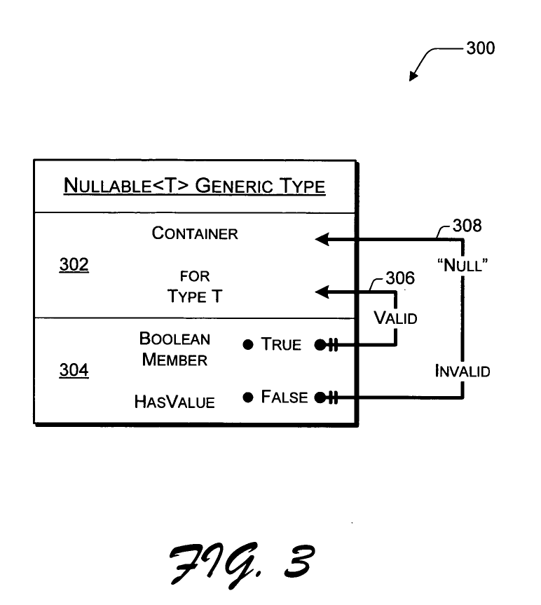

FIG. 3 is an example format 300 for a nullable<T> generic type. Nullable<T> generic type 300 includes at least two portions or fields: a container portion 302 and a Boolean member portion 304. Although only two portions are specifically shown, nullable<T> generic type 300 may alternatively be implemented with three or more portions.

Container 302 may hold any general type T. Examples for general class types T are reference types, value types, and so forth. However, in a described implementation, container 302 holds value types because they do not otherwise have an acceptable, low-risk mechanism for indicating null. Regardless, it is preferable, but not necessary, for container 302 to hold generic (e.g., parameterized) types.

Boolean member 304 is designated “HasValue” because the Boolean value of Boolean member 304 indicates whether or not the type held by container 302 has a value. More specifically, if Boolean member 304 is true, then any value(s) of the type T held by container 302 is valid 306. On the other hand, if Boolean member 304 is false, then any value(s) of the type T held by container 302 are invalid and “null” 308. In this manner, even value types may be unspecified (e.g., uninitialized) and have a null value.

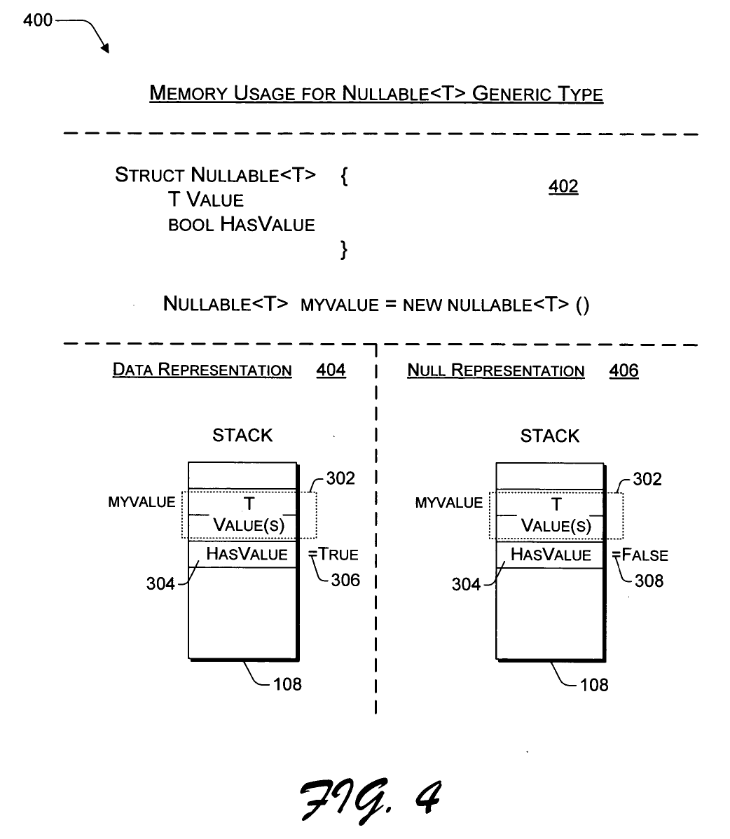

FIG. 4 is an example of memory usage 400 for nullable<T> generic types. A data representation 404 and an actual null representation 406 are illustrated. A nullable type class T is shown and instantiated at 402. The nullable type class T is defined as follows:

| | |
|---|---|
| Struct Nullable<T> | { |
| T Value | |
| bool HasValue | |

}.

A “myvalue” instantiation of the nullable type class T is created with:
Nullable<T> myvalue=new Nullable<T> ( ).
It should be noted that new nullable types are actually instantiated with specified constructed generic types instead of a general type “T” designation, but type “T” has been used here and in FIG. 4 to connote the applicable generality.

If T, the class type held by container 302, is a value type, then the corresponding nullable<T> type may be stored on stack 108 without reference to a heap. Accordingly, both data representation 404 and null representation 406 include a stack 108. (If, however, the class type T held by container 302 is a reference type, then the pointer for the reference class type T and the HasValue Boolean member portion of the corresponding nullable<T> type may be stored on stack 108, with the pointer referencing a heap where the value(s) of the reference class type T are actually stored.)

Continuing with a value type class T example, with data representation 404 for a nullable<T> type, “myvalue” is assigned a location on stack 108 that stores the actual values for the value type class T. In other words, “myvalue” identifies the location on stack 108 at which container portion 302 is stored. More specifically, in a described implementation, “myvalue” equates to a first memory location of possible multiple memory locations that store the values of value type class T.

For example, for a nullable type T instantiation having a value type class T with “field 1” and “field 2”, values of “field 1” and “field 2” are stored on stack 108 starting at “myvalue”. Boolean member 304, as denoted by “HasValue”, is stored proximate to (e.g., preceding, following, and/or adjacent to) container 302. Because stack 108 in data representation 404 is for a non-null situation, the value of HasValue is true 306.

With an actual null representation 406 for a nullable<T> type, “myvalue” is also assigned a location on stack 108 that stores the actual values for the value type class T. In other words, “myvalue” identifies the location on stack 108 at which container portion 302 is stored. More specifically for a described implementation, “myvalue” equates to a first memory location of possible multiple memory locations that store the values of value type class T.

For example, for a nullable type T instantiation having a value type class T with “field 1” and “field 2”, values of “field 1” and “field 2” are stored on stack 108 starting at “myvalue”. Boolean member 304, as denoted by “HasValue”, is stored proximate to (e.g., preceding, following, and/or adjacent to) container 302. Because stack 108 in null representation 406 is for a null situation, the value of HasValue is false 308.

Hence, the nullable<T> generic type provides a mechanism for indicating “null” with objects of general types, including both reference and value types. The null mechanism is enabled because the nullable<T> generic type includes a field, the HasValue Boolean member portion 304, that is reserved for indicating whether the remainder of the nullable<T> type (e.g., container portion 302) is valid and has values or is invalid and is null.

In a described operational implementation, when an instance of a nullable<T> generic type is created, the default condition is to set HasValue of Boolean member 304 to false to indicate a null situation. When an actual value is assigned to one or more variables of a general type being held by container 302, HasValue is automatically set to true to reflect a valid value situation. Other default settings may alternatively be implemented. Examples of such default settings are presented below in a section devoted to a detailed description of a specific example of a nullable<T> generic type framework. (In implementations in which nullable<T> is an immutable type, “changing” a nullable<T> instance from null to having a value after creation thereof may be effectuated by reassigning a new nullable<T> instance to the same existing location in memory.)

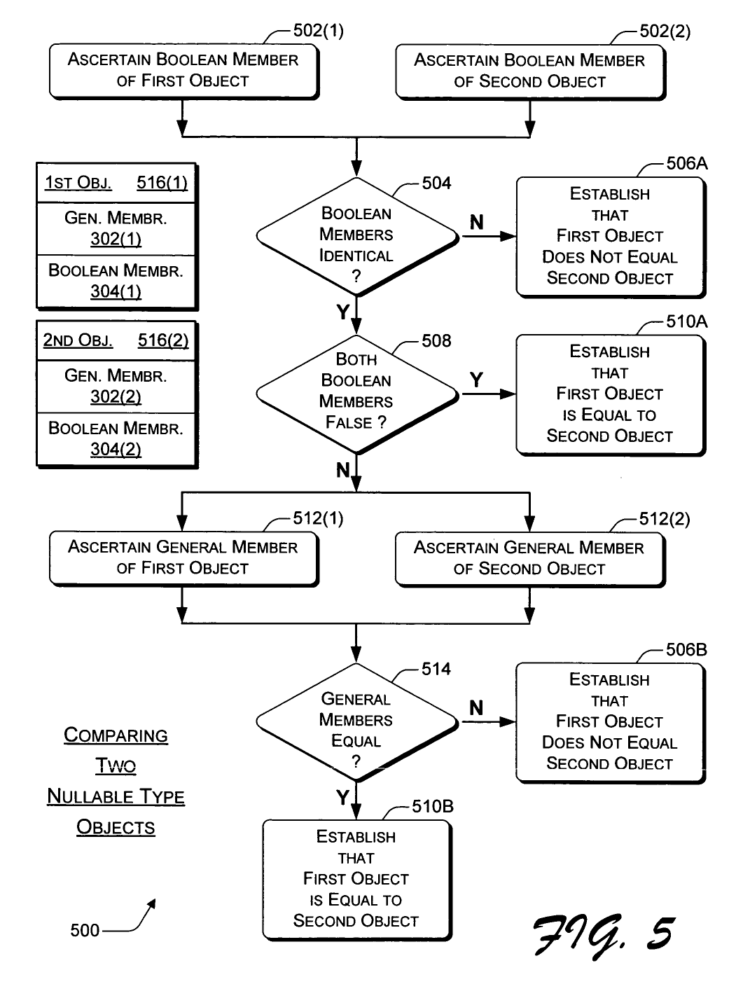

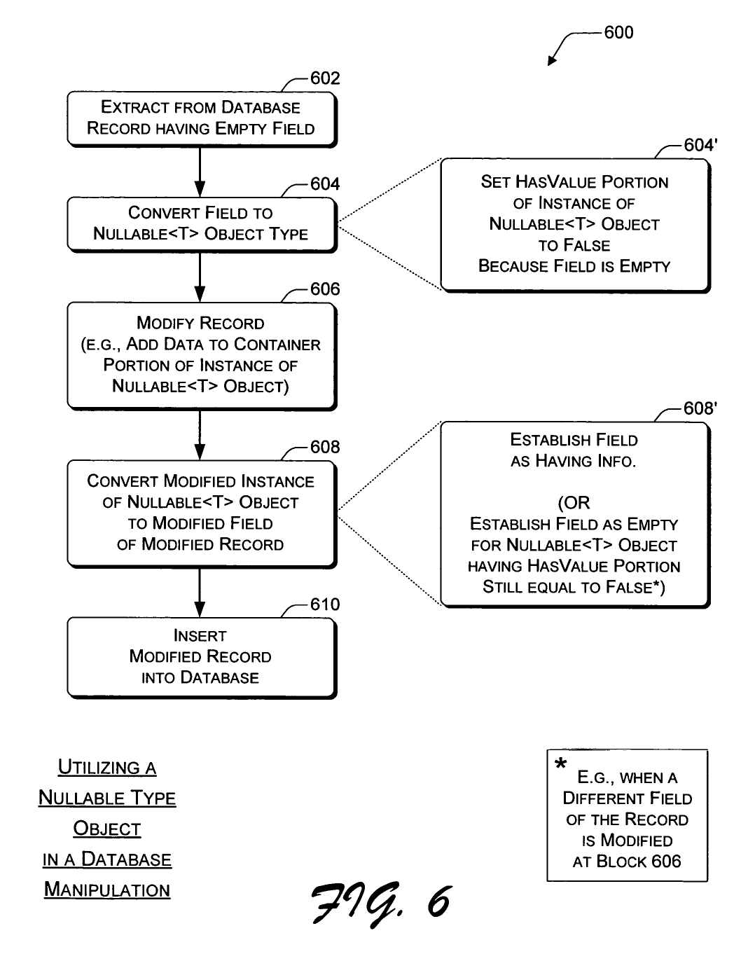

In another described operational implementation, comparisons between objects of the nullable<T> generic type can involve two phases because both Boolean member portions 304 and container portions 302 may be separately compared. An example of such a comparison process is described further below with reference to FIG. 5. As noted above, use of the nullable<T> generic type can be advantageous when accessing and/or manipulating a database, which typically has empty fields. An example of such a database manipulation is described further below with reference to FIG. 6.

### Example Uses of Nullable<T> Generic Type Objects

FIG. 5 is a flow diagram 500 that illustrates an example of a method for comparing two nullable type objects. It should therefore be understood that nullable<T> generic types can be created, utilized, or otherwise implemented without performing the method of FIG. 5. Flow diagram 500 includes eleven (11) blocks 502(1)/502(2), 504, 506A/506B, 508, 510A/510B, 512(1)/512(2), and 514. Although the actions of flow diagram 500 may be performed in other environments, with a variety of hardware and software combinations, and with different nullable<T> generic type implementations, FIGS. 3-4 are used in particular to illustrate certain aspects and examples of the method.

For example, two objects comporting with the format of nullable<T> generic type 300 may be used in the comparison illustrated by flow diagram 500. More specifically, a first object 516(1) of nullable<T> generic type 300 includes a general member being held in a container 302(1) and a Boolean member 304(1). A second object 516(2) of nullable<T> generic type 300 includes a general member being held by a container 302(2) and a Boolean member 304(2).

In a first phase of flow diagram 500, Boolean members 304 of objects 516 are analyzed. If both Boolean members 304 are true, then general members 302 of objects 516 are analyzed in a second phase. Through one or both phases of flow diagram 500, it can be established whether or not first object 516(1) is equal to second object 516(2).

At blocks 502(1) and 502(2), the Boolean member of the first object and the Boolean member of the second object are ascertained (e.g., through get commands). At block 504, it is determined if the Boolean members of the first and second objects are identical. If not, then at block 506A it is established that the first object does not equal the second object. In other words, if one Boolean member 304 is true 306 while the other Boolean member 304 is false 308, then objects 516(1) and 516(2) of nullable<T> generic type 300 cannot be equal.

If, on the other hand, it is determined (at block 504) that the Boolean members of the first and second objects are identical, then at block 508 it is determined if both Boolean members of the first and second objects are false. If so, then at block 510A it is established that the first and second objects are equal. In other words, if both Boolean members 304 are false 308, then objects 516(1) and 516(2) of nullable<T> generic type 300 are equal regardless of the values of general members 302.

If, on the other hand, it is determined (at block 508) that both Boolean members of the first and second objects are not false, then it is known that both Boolean members are true and flow diagram 500 continues with blocks 512(1) and 512(2). At blocks 512(1) and 512(2), the general member of the first object and the general member of the second object are ascertained (e.g., through get commands). At block 514, it is determined if the general members of the first and second objects are equal.

The procedural details for the determination of block 514 depend on the underlying type of general members 302. For example, standard comparison functions for the given underlying reference type, value type, etc. may be utilized as part of the comparison of two nullable type objects. For instance, the actual values of two underlying value type general members 302 may be compared to determine whether or not the overarching nullable type objects are equal (after the Boolean members thereof have been determined to both be true).

If it is determined (at block 514) that the general members of the first and second objects are not equal, then at block 506B it is established that the first object does not equal the second object. If, on the other hand, it is determined (at block 514) that the general members of the first and second objects are equal, then at block 510B it is established that the first object does equal the second object (and vice versa). It should be understood that the actions of the blocks of flow diagram 500 may be effectuated in alternative orders, including partially or fully overlapping. For example, the determination actions of blocks 504, 508, and/or 514 may be effectuated fully or partially in parallel.

FIG. 6 is a flow diagram 600 that illustrates an example of a method for utilizing a nullable type object when manipulating a database. Flow diagram 600 includes five (5) basic blocks 602-610. Although the actions of flow diagram 600 may be performed in other environments, with a variety of hardware and software combinations, and with different nullable<T> generic type implementations, the terminology of FIGS. 3-4 is used in particular to illustrate certain aspects and examples of the method.

At block 602, a record having an empty field is extracted from a database. By way of example only, the intended contents (e.g., ZIP code, name, date, etc.) of this empty field may be suitable for representation as a value type object. However, because the field is empty when the record is extracted from the database, a null condition is to be used to indicate this emptiness in object variable form.

At block 604, the field that is empty is converted to an object of the nullable<T> generic type. As indicated by block 604′, the HasValue portion of the instantiated object of the nullable<T> generic type is set to false because the field is empty. This may be a default condition that need not be explicitly performed with separate coding line(s).

At block 606, the database record can be eventually modified by modifying the extracted record. For example, with respect to the empty field of the extracted record, data can be added to the container portion of the object instance of the nullable<T> generic type to modify the object corresponding to and representing the empty field.

At block 608, the modified object instance of the nullable<T> generic type is converted to a modified field for a modified record of the database. As indicated by block 608′, the previously-empty field of the extracted database record is established as having information as a result of the conversion. Alternatively, in a situation in which a field other than the noted empty field is modified in block 606, then the noted empty field is maintained as being empty by having the HasValue portion of its corresponding nullable<T> generic type object still being false. Furthermore, if the contents of a previously-occupied field are deleted, then this field can be established as empty with an object of the nullable<T> generic type having its HasValue portion set to false.

At block 610, the modified record is inserted into the database. Fields that are represented by objects of the nullable<T> generic type having Boolean members set to false are inserted as being empty. Fields that are represented by objects of the nullable<T> generic type having Boolean members set to true are inserted with contents acquired from the value(s) held by the container portions thereof. In this manner, databases having empty fields may be manipulated using the nullability capacity of nullable<T> generic type objects.

The devices, actions, formats, aspects, features, procedures, components, etc. of FIGS. 1-6 are illustrated in diagrams that are divided into multiple blocks. However, the order, interconnections, interrelationships, layout, etc. in which FIGS. 1-6 are described and/or shown is not intended to be construed as a limitation, and any number of the blocks and/or other illustrated parts can be modified, combined, rearranged, augmented, omitted, etc. in any manner to implement one or more systems, methods, devices, procedures, media, apparatuses, arrangements, etc. for the generic representation of optional values. Furthermore, although the description herein includes references to specific implementations (including the general device of FIG. 7 below), the illustrated and/or described implementations can be implemented in any suitable hardware, software, firmware, or combination thereof and using any suitable memory usage architecture(s), object-oriented paradigm(s), format representation(s), contained object type(s), and so forth.

### Example of Specific Nullable<T> Generic Type Framework

The specific framework for a nullable<T> generic type that is described in this section is an example only. Objects comporting with a nullable<T> generic type to generically represent optional values may be implemented in other manners, such as those described more generally herein above.

### Overview

The nullable generic value type represents an optional value of a given type. For example, nullable<int> represents an optional integer and nullable<string> represents an optional string. The nullable type is useful in a variety of situations, such as to denote nullable columns in a database table or optional attributes in an XML element.

An instance of nullable has at least two properties: HasValue, of type Boolean; and Value, of the type given by the type parameter. When HasValue is true, the instance contains a known value and Value returns that value. When HasValue is false, the instance has an undefined value and an attempt to read the Value property throws an InvalidOperationException exception.

The default value of the nullable type is an instance for which HasValue is false and Value is undefined. The default value is produced by the parameterless constructor of the nullable type. Implementations of the C# language may furthermore provide an implicit conversion from the null literal to the default value. The default value is automatically given to uninitialized fields in an object or uninitialized elements in an array.

When nullable is used with a reference type and an instance is created from a null object reference, the HasValue property of the resulting value is false and an attempt to read the Value property throws an InvalidOperationException exception. This further implies that when HasValue is true, Value is not null.

The nullable type defines an implicit conversion from type T to type nullable<T> and an explicit conversion from type nullable<T> to type T.

The nullable type overloads the == and != operators. Given two instances, x and y, of type nullable, x==y is true either if x.HasValue and y.HasValue are both false, or if x.HasValue and y.HasValue are both true and x.Value.Equals(y.Value) is true. The nullable type overrides and implements the Equals(Object) method in a similar fashion.

Nullable is preferably an immutable type. Once created, individual properties of a nullable instance are not changed. However, nullable may be implemented as a mutable type.

The internal representation of a nullable includes two fields that correspond to the HasValue and Value properties. For example, a nullable<int> instance contains two fields, one of type bool and one of type int. Since a reference type can already represent an undefined state as a null reference, using nullable with a reference type strictly speaking provides no added functionality over the reference type itself. However, nullable may be implemented such that it provides a unified way of representing optional values, be they of reference types or value types.

The nullable type can implement the IFormattable, IComparable, and IComparable interfaces. The implementation of these interfaces provides behavior for the undefined state of a nullable, but otherwise forwards to the implementation provided by the value contained in the nullable.

### Example Usage

The results of the following relatively simple example code are explained below:

Nullable<int> x = 123;
Nullable<int> y = null;
int i = (int)x;
int j = x.Value;
if(y.HasValue) i = y.Value;
Console.WriteLine(i);
Console.WriteLine(j);
Console.WriteLine(x);
Console.WriteLine(y); // writes empty line
Nullable<string> s = “Hello”;
Console.WriteLine(s.Value);

In the assignment to x, the integer value 123 is implicitly converted to a value of type Nullable<int>. Following the conversion and assignment, the value of x.HasValue is true, and the value of x.Value is 123.

In the assignment to y, the null value is implicitly converted to the default value of type Nullable<int>. Following the conversion and assignment, the value of y.HasValue is false, and the value of y.Value is undefined. An attempt to access y.Value would therefore throw an exception.

The assignments to i and j are equivalent ways of obtaining the value of x. Both assign the value 123. The conditional assignment to i in the last line of the example fails to execute because y.HasValue is false.

### Example API Design

The following is an example API design for nullable<T>:

```
  namespace System {
  public struct Nullable<T>: IFormattable, IComparable<Nullable<T>>,
IComparable {
    public Nullable(T value)
    public bool HasValue { get; }
    public T Value { get; }
    public T GetValueOrDefault( );
    public T GetValueOrDefault(T default)
    public static implicit operator Nullable<T>(T value);
    public static explicit operator T(Nullable<T> value);
    public static bool operator ==(Nullable<T> x, Nullable<T> y);
    public static bool operator !=(Nullable<T> x, Nullable<T> y) ;
    public int CompareTo(Nullable<T> other) ;
    public override bool Equals(Nullable<T> other);
    public int CompareTo(object other);
    public override bool Equals(object other);
    public static Nullable<T> FromObject(object value);
    public object ToObject( );
    public override int GetHashCode( ) ;
    public override string ToString( );
    public string ToString(string format) ;
    public string ToString(IFormatProvider provider);
    public string ToString(string format, IFormatProvider provider);
    }
    } // end of namesapce
```

### Example Operating Environment for Computer or Other Device

FIG. 7 illustrates an example computing (or general device) operating environment 700 that is capable of (fully or partially) implementing at least one system, device, apparatus, component, arrangement, protocol, approach, method, procedure, media, API, some combination thereof, etc. for generically representing optional values as described herein. Operating environment 700 may be utilized in the computer and network architectures described below.

Operating environment 700, as well as device(s) thereof and alternatives thereto, may realize objects adhering to the nullable<T> generic type format 300. For example, devices may create (e.g., instantiate), utilize (e.g., in database accessing), etc. nullable<T> generic type objects. Furthermore, such devices may store a description of the format for nullable<T> generic type objects. Moreover, such devices may store all or part of the specific example of a nullable<T> generic type framework as is described above. Devices may also implement one or more aspects of generically representing optional values in other alternative manners.

Example operating environment 700 is only one example of an environment and is not intended to suggest any limitation as to the scope of use or functionality of the applicable device (including computer, network node, entertainment device, mobile appliance, general electronic device, etc.) architectures. Neither should operating environment 700 (or the devices thereof) be interpreted as having any dependency or requirement relating to any one or to any combination of components as illustrated in FIG. 7.

Additionally, the generic representation of optional values may be implemented with numerous other general purpose or special purpose device (including computing system) environments or configurations. Examples of well known devices, systems, environments, and/or configurations that may be suitable for use include, but are not limited to, personal computers, server computers, thin clients, thick clients, personal digital assistants (PDAs) or mobile telephones, watches, hand-held or laptop devices, multiprocessor systems, microprocessor-based systems, set-top boxes, programmable consumer electronics, video game machines, game consoles, portable or handheld gaming units, network PCs, minicomputers, mainframe computers, network nodes, distributed or multi-processing computing environments that include any of the above systems or devices, some combination thereof, and so forth.

Implementations for the generic representation of optional values may be described in the general context of processor-executable instructions. Generally, processor-executable instructions include routines, programs, protocols, objects, interfaces, components, data structures, etc. that perform and/or enable particular tasks and/or implement particular abstract data types. Generically representing optional values, as described in certain implementations herein, may also be practiced in distributed processing environments where tasks are performed by remotely-linked processing devices that are connected through a communications link and/or network. Especially but not exclusively in a distributed computing environment, processor-executable instructions may be located in separate storage media, executed by different processors, and/or propagated over transmission media.

Example operating environment 700 includes a general-purpose computing device in the form of a computer 702, which may comprise any (e.g., electronic) device with computing/processing capabilities. The components of computer 702 may include, but are not limited to, one or more processors or processing units 704, a system memory 706, and a system bus 708 that couples various system components including processor 704 to system memory 706.

Processors 704 are not limited by the materials from which they are formed or the processing mechanisms employed therein. For example, processors 704 may be comprised of semiconductor(s) and/or transistors (e.g., electronic integrated circuits (ICs)). In such a context, processor-executable instructions may be electronically-executable instructions. Alternatively, the mechanisms of or for processors 704, and thus of or for computer 702, may include, but are not limited to, quantum computing, optical computing, mechanical computing (e.g., using nanotechnology), and so forth.

System bus 708 represents one or more of any of many types of wired or wireless bus structures, including a memory bus or memory controller, a point-to-point connection, a switching fabric, a peripheral bus, an accelerated graphics port, and a processor or local bus using any of a variety of bus architectures. By way of example, such architectures may include an Industry Standard Architecture (ISA) bus, a Micro Channel Architecture (MCA) bus, an Enhanced ISA (EISA) bus, a Video Electronics Standards Association (VESA) local bus, a Peripheral Component Interconnects (PCI) bus also known as a Mezzanine bus, some combination thereof, and so forth.

Computer 702 typically includes a variety of processor-accessible media. Such media may be any available media that is accessible by computer 702 or another (e.g., electronic) device, and it includes both volatile and non-volatile media, removable and non-removable media, and storage and transmission media.

System memory 706 includes processor-accessible storage media in the form of volatile memory, such as random access memory (RAM) 740, and/or non-volatile memory, such as read only memory (ROM) 712. A basic input/output system (BIOS) 714, containing the basic routines that help to transfer information between elements within computer 702, such as during start-up, is typically stored in ROM 712. RAM 710 typically contains data and/or program modules/instructions that are immediately accessible to and/or being presently operated on by processing unit 704.

Computer 702 may also include other removable/non-removable and/or volatile/non-volatile storage media. By way of example, FIG. 7 illustrates a hard disk drive or disk drive array 716 for reading from and writing to a (typically) non-removable, non-volatile magnetic media (not separately shown); a magnetic disk drive 718 for reading from and writing to a (typically) removable, non-volatile magnetic disk 720 (e.g., a “floppy disk”); and an optical disk drive 722 for reading from and/or writing to a (typically) removable, non-volatile optical disk 724 such as a CD, DVD, or other optical media. Hard disk drive 716, magnetic disk drive 718, and optical disk drive 722 are each connected to system bus 708 by one or more storage media interfaces 726. Alternatively, hard disk drive 716, magnetic disk drive 718, and optical disk drive 722 may be connected to system bus 708 by one or more other separate or combined interfaces (not shown).

The disk drives and their associated processor-accessible media provide non-volatile storage of processor-executable instructions, such as data structures, program modules, and other data for computer 702. Although example computer 702 illustrates a hard disk 716, a removable magnetic disk 720, and a removable optical disk 724, it is to be appreciated that other types of processor-accessible media may store instructions that are accessible by a device, such as magnetic cassettes or other magnetic storage devices, flash memory, compact disks (CDs), digital versatile disks (DVDs) or other optical storage, RAM, ROM, electrically-erasable programmable read-only memories (EEPROM), and so forth. Such media may also include so-called special purpose or hard-wired IC chips. In other words, any processor-accessible media may be utilized to realize the storage media of the example operating environment 700.

Any number of program modules (or other units or sets of instructions/code) may be stored on hard disk 716, magnetic disk 720, optical disk 724, ROM 712, and/or RAM 740, including by way of general example, an operating system 728, one or more application programs 730, other program modules 732, and program data 734. These program modules may define, create, use, etc. nullable<T> generic type objects as described herein for generically representing optional values.

A user may enter commands and/or information into computer 702 via input devices such as a keyboard 736 and a pointing device 738 (e.g., a “mouse”). Other input devices 740 (not shown specifically) may include a microphone, joystick, game pad, satellite dish, serial port, scanner, and/or the like. These and other input devices are connected to processing unit 704 via input/output interfaces 742 that are coupled to system bus 708. However, input devices and/or output devices may instead be connected by other interface and bus structures, such as a parallel port, a game port, a universal serial bus (USB) port, an infrared port, an IEEE 1394 (“Firewire”) interface, an IEEE 802.11 wireless interface, a Bluetooth® wireless interface, and so forth.

A monitor/view screen 744 or other type of display device may also be connected to system bus 708 via an interface, such as a video adapter 746. Video adapter 746 (or another component) may be or may include a graphics card for processing graphics-intensive calculations and for handling demanding display requirements. Typically, a graphics card includes a graphics processing unit (GPU), video RAM (VRAM), etc. to facilitate the expeditious display of graphics and performance of graphics operations. In addition to monitor 744, other output peripheral devices may include components such as speakers (not shown) and a printer 748, which may be connected to computer 702 via input/output interfaces 742.

Computer 702 may operate in a networked environment using logical connections to one or more remote computers, such as a remote computing device 750. By way of example, remote computing device 750 may be a peripheral device, a personal computer, a portable computer (e.g., laptop computer, tablet computer, PDA, mobile station, etc.), a palm or pocket-sized computer, a watch, a gaming device, a server, a router, a network computer, a peer device, another network node, or another device type as listed above, and so forth. However, remote computing device 750 is illustrated as a portable computer that may include many or all of the elements and features described herein with respect to computer 702.

Logical connections between computer 702 and remote computer 750 are depicted as a local area network (LAN) 752 and a general wide area network (WAN) 754. Such networking environments are commonplace in offices, enterprise-wide computer networks, intranets, the Internet, fixed and mobile telephone networks, ad-hoc and infrastructure wireless networks, mesh networks, other wireless networks, gaming networks, some combination thereof, and so forth. Such networks and logical and physical communications connections are additional examples of transmission media.

When implemented in a LAN networking environment, computer 702 is usually connected to LAN 752 via a network interface or adapter 756. When implemented in a WAN networking environment, computer 702 typically includes a modem 758 or other component for establishing communications over WAN 754. Modem 758, which may be internal or external to computer 702, may be connected to system bus 708 via input/output interfaces 742 or any other appropriate mechanism(s). It is to be appreciated that the illustrated network connections are examples and that other manners for establishing communication link(s) between computers 702 and 750 may be employed.

In a networked environment, such as that illustrated with operating environment 700, program modules or other instructions that are depicted relative to computer 702, or portions thereof, may be fully or partially stored in a remote media storage device. By way of example, remote application programs 760 reside on a memory component of remote computer 750 but may be usable or otherwise accessible via computer 702. Also, for purposes of illustration, application programs 730 and other processor-executable instructions such as operating system 728 are illustrated herein as discrete blocks, but it is recognized that such programs, components, and other instructions reside at various times in different storage components of computing device 702 (and/or remote computing device 750) and are executed by processor(s) 704 of computer 702 (and/or those of remote computing device 750).

Although systems, media, devices, methods, procedures, apparatuses, techniques, schemes, approaches, procedures, arrangements, and other implementations have been described in language specific to structural, logical, algorithmic, and functional features and/or diagrams, it is to be understood that the invention defined in the appended claims is not necessarily limited to the specific features or diagrams described. Rather, the specific features and diagrams are disclosed as example forms of implementing the claimed invention.

What is claimed is:

1. One or more processor-accessible media comprising processor-executable instructions that, when executed, direct a device to instantiate an object of a type comprising:
a first portion including a container that holds an instance of an object of a generic type; and
a second portion including a Boolean member that can be true or false;
wherein the object of the generic type is valid when the Boolean member is true and null when the Boolean member is false.

2. The one or more processor-accessible media as recited in claim 1, wherein the generic type comprises at least one of a reference type or a value type.

3. The one or more processor-accessible media as recited in claim 1, wherein the generic type comprises a value type selected from the group comprising integer, long, and date/time.

4. The one or more processor-accessible media as recited in claim 1, wherein the processor-executable instructions, when executed, direct the device to perform actions comprising:
storing the object of the generic type on a stack of the device; and
storing the Boolean member on the stack of the device.

5. The one or more processor-accessible media as recited in claim 1, wherein at least a portion of the processor-executable instructions comprise at least part of a program that is capable of accessing a database.

6. The one or more processor-accessible media as recited in claim 1, wherein the one or more processor-accessible media comprise at least one of (i) one or more storage media and (ii) one or more transmission media.

7. A device comprising:
a memory having a stack, the stack including:
an instance of a generic object type; and
a Boolean value adjacent to the instance of the generic object type, the Boolean value capable of being true or false;
wherein the Boolean value controls a validity status of the instance of the generic object type.

8. The device as recited in claim 7, wherein the instance of the generic object type is valid if and only if the Boolean value is true.

9. The device as recited in claim 7, wherein the instance of the generic object type is invalid and considered null when the Boolean value is false.

10. The device as recited in claim 7, wherein the instance of the generic object type comprises a value type that is rendered nullable by the adjacent Boolean value.

11. The device as recited in claim 7, wherein the instance of the generic object type precedes the adjacent Boolean value on the stack.

12. An arrangement for generically representing optional values, the arrangement comprising:
container means for holding an object of a generic type; and
validity means for indicating whether or not the object of the generic type is valid;
wherein the container means and the validity means jointly form a nullable type generic object.

13. The arrangement as recited in claim 12, wherein the arrangement comprises a device that includes a memory having a stack; and wherein the stack stores the container means and the validity means.

14. The arrangement as recited in claim 12, wherein the arrangement comprises one or more processor-accessible media including processor-executable instructions that, when executed, cause the container means and the validity means to be stored together on a stack of a device.

15. The arrangement as recited in claim 12, wherein the object of the generic type comprises at least one of an object of a reference type or an object of a value type.

16. The arrangement as recited in claim 12, wherein the validity means comprises a Boolean value that indicates validity when true and invalidity when false.

17. A method comprising:
determining if a Boolean member of a first object and a Boolean member of a second object are both false;
if the Boolean member of the first object and the Boolean member of the second object are both determined to be false, then establishing that the first object and the second object are equal; and
if the Boolean member of the first object and the Boolean member of the second object are both true, then determining if a general member of the first object and a general member of the second object are equal.

18. The method as recited in claim 17, further comprising:
if the general member of the first object and the general member of the second object are not determined to be equal, then establishing that the first object and the second object are not equal; and
if the general member of the first object and the general member of the second object are determined to be equal, then establishing that the first object and the second object are equal.

19. The method as recited in claim 17, further comprising:
determining if the Boolean member of the first object and the Boolean member of the second object are both true.

20. The method as recited in claim 17, further comprising:
ascertaining the Boolean member of the first object;
ascertaining the Boolean member of the second object;
ascertaining the general member of the first object; and
ascertaining the general member of the second object.

21. The method as recited in claim 17, further comprising:
determining if the Boolean member of the first object is identical to the Boolean member of the second object; and
if the Boolean member of the first object is not determined to be identical to the Boolean member of the second object, then establishing that the first object and the second object are not equal.

22. The method as recited in claim 21, further comprising:
if the Boolean member of the first object is determined to be identical to the Boolean member of the second object, then performing the determining if the Boolean member of the first object and the Boolean member of the second object are both false.

23. The method as recited in claim 17, wherein the determining if a general member of the first object and a general member of the second object are equal further comprises:
applying a standard comparison function for an underlying general type of the general members of the first and second objects.

24. The method as recited in claim 17, wherein the determining if a general member of the first object and a general member of the second object are equal further comprises:
comparing one or more values of a reference type of the first object to one or more values of a reference type of the second object.

25. The method as recited in claim 17, wherein the determining if a general member of the first object and a general member of the second object are equal further comprises:
comparing one or more values of a value type of the first object to one or more values of a value type of the second object.

26. The method as recited in claim 25, wherein the value type of the general members of the first and second objects are selected from the group comprising integer and long.

27. One or more processor-accessible media comprising processor-executable instructions that, when executed, direct a device to instantiate and/or utilize a nullable<T> object, the nullable<T> object comprising:
a container holding a value type object; and
a Boolean member that can be true or false;
wherein the value type object has a value when the Boolean member is true, and the value type object is null when the Boolean member is false.

28. The one or more processor-accessible media as recited in claim 27, wherein the value type object comprises at least one of an integer type or a long type.

29. The one or more processor-accessible media as recited in claim 27, wherein the processor-executable instructions, when executed, direct the device to store the Boolean member adjacent to the value type object on a stack of the device.

30. The one or more processor-accessible media as recited in claim 27, wherein the processor-executable instructions, when executed, further direct the device to instantiate and/or utilize the nullable<T> object in an immutable fashion.
